(19) United States
(12) Patent Application Publication
(10) Pub. No.: US 2006/0029345 A1
(43) Pub. Date: Feb. 9, 2006

(54) Method of processing optical fiber

(75) Inventor: Masahiro Fushimi, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/190,867

(22) Filed: Jul. 28, 2005

(30) Foreign Application Priority Data
Aug. 3, 2004 (JP) 2004-226340

(51) Int. Cl. G02B 6/02

(52) U.S. Cl. 385/123; 385/38

(57) ABSTRACT

A method of processing an optical fiber having a first facet and a second facet is provided. The method includes the steps of applying a photosensitive material to a region on the first facet at least including an entirety of a core in a generally uniform thickness, irradiating light of a predetermined wavelength from the second facet through an inside of the optical fiber, with the first facet dipped in a predetermined solution that has generally the same refractive index as that of the photosensitive material, so as to expose only the photosensitive material applied to the core in the first facet, and forming a level gap at a boundary between a core facet and a clad facet in the first facet, at least after the first facet lifted out of the solution undergoes development.

### INCORPORATION BY REFERENCE

This application claims priority of Japanese Patent Application No. 2004-226340, Aug. 3, 2004, the entire subject matter of the application being incorporated herein by reference.

### BACKGROUND OF THE INVENTION

The present invention relates to a method of processing an optical fiber employed in an optical communication apparatus.

An optical communication apparatus for transmitting light carrying information to an optical communication network has been widely used. Such an optical communication apparatus includes a laser diode (LD), a lens that converges light from the LD, and an optical fiber. An optical communication module that serves as an ONU (Optical Network Unit), through which optical fiber communication is introduced into a subscriber's house, generally includes a photoreceptor and a WDM (Wavelength Division Multiplex) filter that separates light of different wavelengths, for performing interactive communication in which a single optical fiber is used for both transmission and reception in common.

In such an optical communication module, signal light from the LD has to be introduced to a generally central portion of a core of the optical fiber, so as to transmit or receive the signal light through the optical fiber. In other words, the LD has to be precisely positioned with respect to the core of only a few microns in diameter, of the optical fiber. In Japanese Patent Provisional Publication No. 2004-163557, the assignee of the present application has proposed a technique of processing a facet of an optical fiber to which light from the LD is introduced (a light receiving facet) in a particular shape.

The method of processing an optical fiber disclosed in the publication refers to a method of forming a level gap between a core facet and a clad facet on the light receiving facet of the optical fiber. To be more detailed, the method of processing an optical fiber according to the publication includes applying a photosensitive material to the light receiving facet and irradiating a light from the opposite facet of the optical fiber for exposure. By this method, the clad serves as a mask so that only a portion of the photosensitive material applied to the core facet is exposed. As a result a level gap of a predetermined dimension can be formed between the core facet and the clad facet, by which a boundary between the core facet and the clad facet is clearly defined, on the light receiving facet.

The publication also proposes a precise positioning process for the LD and the optical fiber. The process according to the publicaition utilizes the optical fiber processed by the above processing method. Specifically, light from the LD is introduced to the light receiving facet with the level gap. A portion of the light reflected by the light receiving facet is received by a photo detector, which detects a fluctuation in light intensity distribution caused by the level gap. Then based on the detected light intensity distribution, a negative feedback control is performed so that the center of the incident position on the light receiving facet (spot forming position) of the light from the LD is located substantially at the center of the core facet. Accordingly, for executing the positioning with high precision, the position of the level gap formed on the light receiving facet of the optical fiber by the above processing method has to accurately coincide with the boundary between the core facet and the clad facet on the light receiving facet.

When performing the foregoing processing method, in the case where the photosensitive material applied to the light receiving facet and the ambience (in this case, air) have a large difference in refractive index, a portion of light that has passed through the optical fiber from the opposite facet may be reflected at the interface between the photosensitive material and air, to thereby expose the photosensitive material in a region not intended for the exposure to light, and resultantly the level gap may be formed at a position slightly shifted from the boundary between the core facet and the clad facet.

It has been discovered that the foregoing phenomenon is more prone to take place, especially when the optical fiber is formed such that the optical axis of the optical fiber is not perpendicular to the light receiving facet of the optical fiber (so that an optical path of the light from the LD and an optical path of light reflected by the light receiving facet of the optical fiber are shifted with respect to each other), in order to reduce the number of parts in the optical communication module in which the positioning operation is executed.

If the photosensitive material applied to a region except the core facet (in other words, applied to the clad facet) is exposed, it would be difficult to bring the center of the spot forming position to the center of the core facet, on the light receiving facet, and thus a considerably long time would be required for the positioning process. Accordingly, further improvement in the method of processing an optical fiber has been sought, to effectively prevent the foregoing phenomenon and thus to realize a quick and accurate positioning process.

### SUMMARY OF THE INVENTION

The present invention is advantageous in that a method of processing an optical fiber used in an optical communication module, which enables forming a level gap precisely coinciding with a boundary between a core facet and a clad facet, irrespective of an inclination of a light receiving facet with respect to an optical axis of the optical fiber.

According to an aspect of the invention, there is provided a method of processing an optical fiber having a first facet and a second facet. The method includes the steps of applying a photosensitive material to a region on the first facet at least including an entirety of a core in a generally uniform thickness, irradiating light of a predetermined wavelength from the second facet through an inside of the optical fiber, with the first facet dipped in a predetermined solution that has generally the same refractive index as that of the photosensitive material, so as to expose only the photosensitive material applied to the core in the first facet, and forming a level gap at a boundary between a core facet and a clad facet in the first facet, at least after the first facet lifted out of the solution undergoes development.

With this configuration, since the first facet of the optical fiber is dipped in the predetermined solution having generally the same refractive index as the photosensitive material, a difference in refractive index between the photosensitive material and the ambience (i.e., the solution) can be minimized. Accordingly, reflection of light introduced from the second facet at an interface (between the photosensitive material and the ambience) can be sufficiently suppressed, and therefore only the photosensitive material applied to the core facet can be exposed with high precision. As a result, the level gap can be formed precisely at the boundary between the core facet and the clad facet in the first facet.

Optionally, in the applying step, the photosensitive material may be applied to an entire region on the first facet.

Still optionally, in the applying step, a negative resist may be used as the photosensitive material.

Alternatively, in the applying step, a positive resist may be used as the photosensitive material.

With regard to the above mentioned case where the negative or positive resist is used as the photosensitive material, the forming the level gap step may includes the steps of performing an etching, after the development, on a region where the resist is no longer present, and stripping the resist remaining on the first facet, after the etching.

With regard to the above mentioned case where the negative or positive resist is used as the photosensitive material, the forming the level gap step may include the steps of filling a region where the resist has been removed in the first facet with a material that has generally the same refractive index as an end portion of the optical fiber corresponding to the region, and removing the resist remaining on the first facet after the filling step.

Optionally, in the applying process, a photo-curing material that is optically transparent and hardens under light of a predetermined wavelength may be used as the photosensitive material.

Still optionally, a height of the level gap may be determined depending on a thickness of the photo-curing material applied to the first facet.

Still optionally, the photo-curing material may have a lower refractive index than a clad of the optical fiber.

Still optionally, a holder larger in diameter than the optical fiber may be used to hold at least a portion of the optical fiber.

Still optionally, the optical fiber may be held by the holder such that the first facet and a facet of the holder are generally flush.

Still optionally, in the applying process, the photosensitive material may be applied to an entire region including the first facet and the facet of the holder.

Still optionally, the first facet may not be orthogonal to an optical axis of the optical fiber.

In a particular case, a difference between a refractive index of the predetermined solution and a refractive index of the photosensitive material may be smaller than or equal to

### BRIEF DESCRIPTION OF THE ACCOMPANYING DRAWINGS

FIG. 1 is a perspective view showing an optical fiber processed by a method of processing according to a first to a third embodiments of the present invention;

FIGS. 2A to 2F are schematic side views for explaining the method of processing an optical fiber according to the first embodiment;

FIG. 3 is a schematic side view showing the optical fiber dipped in a solution, in an exposing process according to the embodiments;

FIGS. 4A to 4F are schematic side views for explaining the method of processing an optical fiber according to the second embodiment;

FIGS. 5A to 5D are schematic side views for explaining the method of processing an optical fiber according to the third embodiment;

FIG. 6 is a perspective view showing an optical fiber processed by a method of processing according to a fourth embodiment;

FIGS. 7A to 7F are schematic side views for explaining the method of processing an optical fiber according to the fourth embodiment; and

FIG. 8 is a schematic diagram showing a configuration of an optical communication module including the optical fiber processed by the method of processing according to the first to the third embodiments.

### DETAILED DESCRIPTION OF THE EMBODIMENTS

Hereinafter, embodiments according to the invention are described with reference to the accompanying drawings. As described in detail below, an optical fiber is manufactured by a method of processing an optical fiber according to the embodiment. The optical fibers processed by the method according to the embodiments are all intended for use in an optical communication module, so as to serve to transmit signal light from an LD to an optical communication network. The essence of the method of processing an optical fiber lies in forming a level gap at a boundary between a core facet and a clad facet, on a light receiving facet of the optical fiber. Such processing allows clearly defining the boundary between the core facet and the clad facet on the light receiving facet. Accordingly, in the optical communication module implemented with the optical fiber processed by the method according to the embodiment, a high-precision positioning can be executed, such as introducing the center of a spot created by light from the LD to the center of the core, based on an optical property introduced by the level gap.

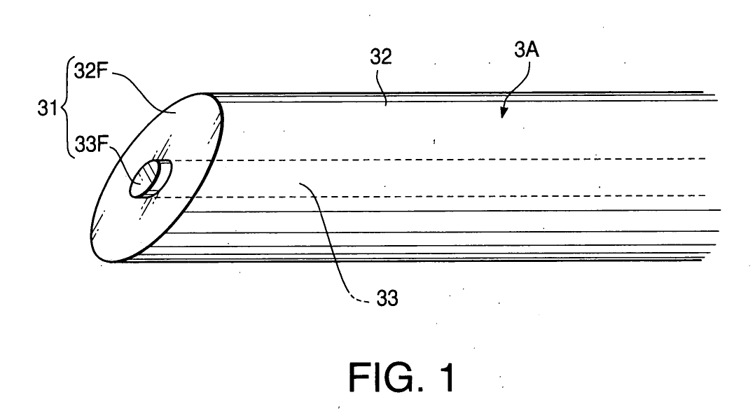

FIG. 1 illustrates an optical fiber 3A processed by a processing method according to a first to a third embodiments. As shown therein, the optical fiber 3A includes a clad 32 and a core 33. A first facet (light receiving facet) 31 to which light from an LD is introduced when implemented in an optical communication module is cut off along a plane that is not perpendicular to an extension of the optical fiber 3A (i.e., an optical axis of the optical fiber 3A). A level gap is formed at a boundary between a clad facet 32F and a core facet 33F. More specifically, the optical fiber 3A is processed such that the core facet 33F protrudes along the optical axis of the optical fiber 3A, by a predetermined amount from the clad facet 32F, on the first facet 31. The level gap is formed such that the protruding core facet 33F becomes generally parallel to the clad facet 32F.

The predetermined amount, i.e. the protruding height of the core facet 33F is set to be smaller than λ/(4 n), so as to cause diffraction when light is incident on both of the clad facet 32F and the protruding core facet 33F. Here, λ represents the wavelength of the incident light, and n represents a refractive index of the medium. In this embodiment, the predetermined amount is set to λ/8, on the assumption that the medium is air (i.e. n=1), so as to attain highest diffraction efficiency of the diffracted light generated out of the light reflected upon reaching the core 33 and the clad 32.

### First Embodiment

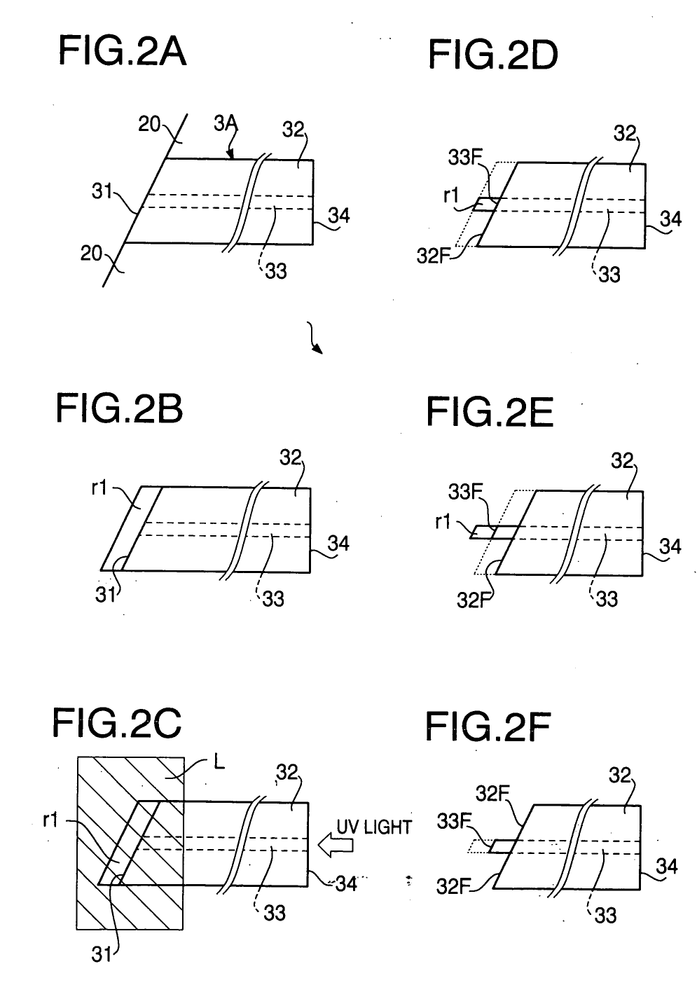

Hereafter, a method of processing an optical fiber according to a first embodiment will be described. FIGS. 2A to 2F are schematic side views for explaining the method of processing an optical fiber according to the first embodiment. Referring to FIG. 2A, the optical fiber 3A includes a second facet 34, on the opposite side to the first facet 31. The first facet 31 of the optical fiber 3A is cut off in advance by a plane not orthogonal with respect to the optical axis of the optical fiber 3A.

The optical fiber 3A shown in FIG. 2A is already retained at a region close to the first facet 31, by a capillary 20 having a larger diameter than the optical fiber 3A. Employing the capillary 20 improves operability and security in executing the processing work of the optical fiber. The optical fiber 3A is retained such that the first facet 31 becomes flush with a facet of the capillary 20. In other words, the inclination of the facet of the capillary 20 is aligned with the inclination of the first facet 31. As from FIG. 2B and onward, the capillary 20 is not shown for the sake of explicitness in explanation. This is also the case with the drawings for explaining the method of processing according to other embodiments, to be subsequently described.

Referring to FIG. 2B, a negative resist r1 is applied to the entire region of the first facet 31 of the optical fiber 3A and the facet of the capillary 20, in a generally uniform thickness (coating process). For applying the negative resist r1, a known technique may be employed such as spreading the negative resist r1 dropped onto the first facet 31 by a spin coater (spin coating), dipping the first facet 31 in a solution of the negative resist r1 (dip coating), and spraying the negative resist r1 toward the first facet 31 (spray coating).

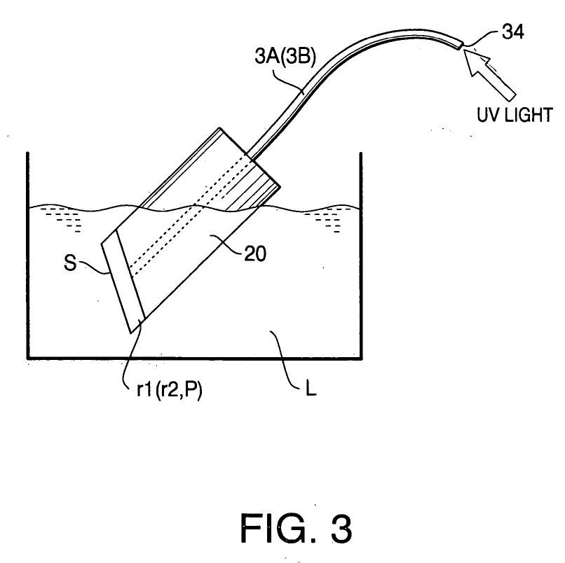

Once the negative resist r1 has been uniformly applied to the entire region of the first facet 31 (and the facet of the capillary 20), an exposing process is carried out. In the exposing process, firstly the end portion of the optical fiber on the side of the first facet 31 is dipped in a predetermined solution L, as shown in FIG. 2C. FIG. 3 illustrates a state where the optical fiber 3A and the capillary 20 are dipped in the solution L. The solution L has a refractive index equivalent to that of the photosensitive material (the negative resist r1, in this case). In this embodiment specifically, benzene having a refractive index of 1.49 is employed as the solution L, assuming that the negative resist that has a refractive index of 1.49 is employed.

With the end portion of the optical fiber on the side of the first facet 31 dipped in the solution L, a UV light is irradiated from the side of the second facet 34. The UV light incident on the second facet 34 passes through inside the core 33, and reaches the negative resist r1.

The solution L has the equivalent refractive index to that of the negative resist r1, as already stated. Accordingly, since there is no difference in refractive index between the photosensitive material and the ambience (the solution L in this case), the reflection component at the interface S can be effectively reduced. Also, the optical fiber is constructed such that the core 33 and the clad 32 are in close contact to each other throughout the entire length. Therefore, the UV light that has passed through the core 33 and been emitted through the first facet 31 solely exposes the portion of the negative resist r1 applied to the core facet 33F, with extremely high precision.

Also, when the UV light is thus irradiated from the side of the second facet 34 instead of from the side of the first facet 31, the clad 32 serves as a mask. Therefore a mask making process can be eliminated, and thereby the process is simplified and shortened.

The irradiation time of the UV light is determined such that the negative resist r1 applied to the core facet 33F is sufficiently exposed. After the exposure, a level gap forming process is carried out, in which development is first performed, so that an unexposed portion of the negative resist r1, i.e. the negative resist r1 applied to the clad facet 32F, is dissolved and removed (developing process).

FIG. 2D depicts the state of the optical fiber 3A after the developing process. In view of the optical fiber 3A shown therein, it is explicitly understood that the irradiation of the UV light from the side of the second facet 34 leaves only the portion of the negative resist r1 in the region corresponding to the core facet 33F generally in a column shape including the core facet 33F as its bottom face, in other words forms a level gap between the core facet 33F and the clad facet 32F, on the first facet 31.

Referring to FIG. 2D, the optical fiber 3A that has undergone the exposing process and is still carrying the negative resist r1 applied to the core facet 33F is then subjected to an etching process performed on the clad 32 where the negative resist r1 has been removed (etching process). The etching process is generally classified into a wet etching and a dry etching, and either may be employed in the method of processing according to the present invention. In this embodiment the dry etching is adopted, in order to form the level gap between the core facet 33F and the clad facet 32F with high precision, since the accuracy in this aspect is essential for detecting a light intensity distribution necessary for high-precision position detection of light. For the dry etching process according to this embodiment, a FAB (fast atomic beam) processor may be suitably employed, because of its excellent anisotropic etching performance. FIG. 2E depicts the optical fiber 3A that has undergone the etching process such that the height of the level gap between the core facet 33F and the clad facet 32F becomes λ/8. FIG. 2F depicts the optical fiber 3A from which the negative resist r1 has been stripped. At this stage, the optical fiber 3A obtains the structure shown in FIG. 1.

By the method of processing an optical fiber according to the first embodiment, the negative resist r1 is utilized as the photosensitive material, and the level gap is formed at the boundary between the core facet 33F and the clad facet 32F by the etching process.

### Second Embodiment

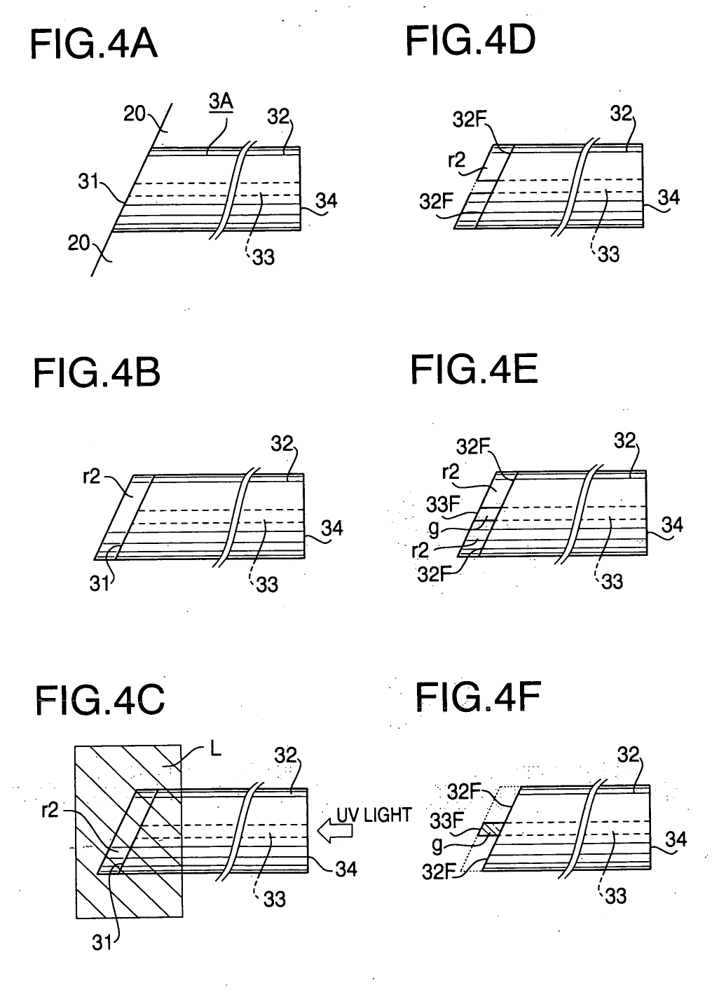

The method of processing according to the present invention, however, allows forming the level gap without performing the etching process. FIGS. 4A to 4F are schematic side views for explaining a method of processing an optical fiber according to a second embodiment. The method of processing according to the second embodiment is similar to the method of processing in the first embodiment up to the exposing process, except that a positive resist r2 is employed as the photosensitive material. Accordingly, the states of the optical fiber 3A shown in FIGS. 4A to 4C are generally the same as those shown in FIGS. 2A to 2C, respectively.

In the method of processing according to the second embodiment, a predetermined material g is filled in a space defined by the core facet 33F of the optical fiber under the state shown in FIG. 4D and a portion of the positive resist r2 that has not been removed by a developing process, so as to form the level gap (FIG. 4E). As the material g, for example a glass (SiO₂) may be suitably employed. A refractive index of the glass (SiO₂) may be equal to the optical fiber (e.g., the core 33). The predetermined material g is filled until the height of the level gap reashes a thickness of λ/8. Then as shown in FIG. 4F, the positive resist r2 is removed or lifted off (resist stripping process), so that the optical fiber 3A shown in FIG. 1 can be obtained, as in the first embodiment.

### Third Embodiment

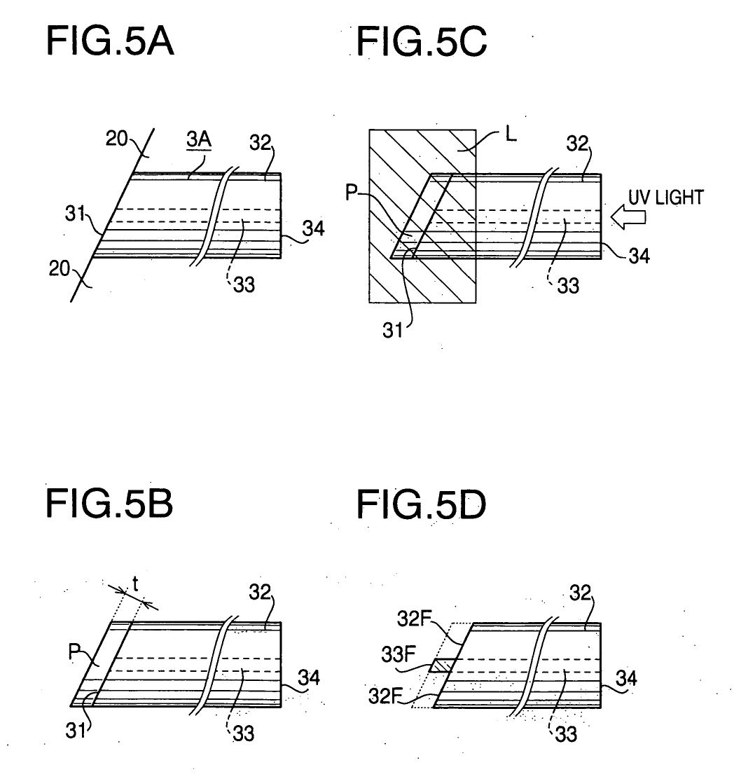

FIGS. 5A to 5D are schematic side views for explaining a method of processing an optical fiber according to a third embodiment. The method of processing according to the third embodiment is similar to the method of processing in the first embodiment up to the exposing process, except that a photo-curing resin P is applied to the first facet 31 as the photosensitive material. Accordingly, the states of the optical fiber 3A shown in FIGS. 5A to 5C are generally the same as those shown in FIGS. 2A to 2C, respectively. The photo-curing resin herein employed is a resin having both light transmitting and UV-curing natures, such as an epoxy resin, an acrylate resin or a silicone resin.

In the third embodiment, the film thickness t of the photo-curing resin P applied in a coating process shown in FIG. 5B results in constituting, as it is, the level gap between the core facet 33F and the clad facet 32F, on the first facet 31. Accordingly, adjusting the film thickness t results in forming the level gap of a desired height (λ/8 in this case) on the first facet 31. The film thickness t can be adjusted simply by selecting one of the foregoing coating methods. Further, in each of those coating methods, modifying a coating condition allows adjusting the film thickness t. When employing the spin coating for example, the film thickness t can be increased or decreased by changing the rotating speed. Moreover, controlling the viscosity of the photo-curing resin P also leads to adjusting the film thickness t. Further, the modification of the condition may include changing the lifting speed of the optical fiber out of the photo-curing material solution in the dip coating, or changing the mixing ratio of the compressed air and the photo-curing material solution, in the spray coating.

In the method of processing according to the third embodiment also, an exposing process is followed by a level gap forming process. The difference is that the level gap forming process in the third embodiment only includes a developing process. Specifically, through the developing process the unexposed portion of the photo-curing resin P, i.e. the photo-curing resin P coated to the clad facet 32F, is dissolved and removed. At this stage, only the portion of the photo-curing resin P applied to the core facet 33F is left generally in a column shape including the core facet 33F as its bottom face, in other words the level gap is formed precisely at the boundary between the core facet 33F and the clad facet 32F, on the first facet 31. FIG. 5D depicts the optical fiber 3A that has undergone the developing process.

According to the third embodiment, since the etching process can be skipped, reduction in labor and cost required for the process of the optical fiber is attained.

The method of processing an optical fiber according to the first to the third embodiments is for forming a level gap in a protruding shape on the core facet 33F, as shown in FIG. 1.

### Fourth Embodiment

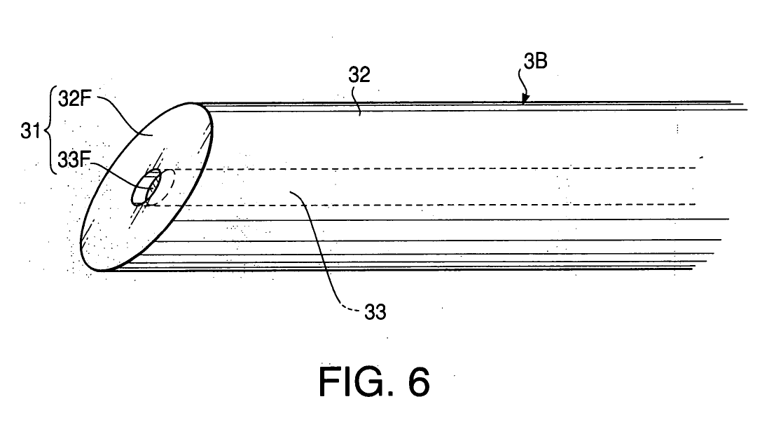

In contrast, the method of processing an optical fiber according to the present invention can also form a recessed portion on the core facet 33F, thus to create a level gap. FIG. 6 is a perspective view showing an optical fiber 3B processed by a method of processing according to a fourth embodiment, described here below. In the optical fiber 3B, same constituents as those of the optical fiber 3A are given identical numerals, and description thereof will not be repeated. As shown in FIG. 6, the optical fiber 3B is constituted such that on the first facet 31 the core facet 33F is recessed by a predetermined amount along the optical axis of the optical fiber 3B, and the core facet 33F thus recessed and the clad facet 32F are generally parallel.

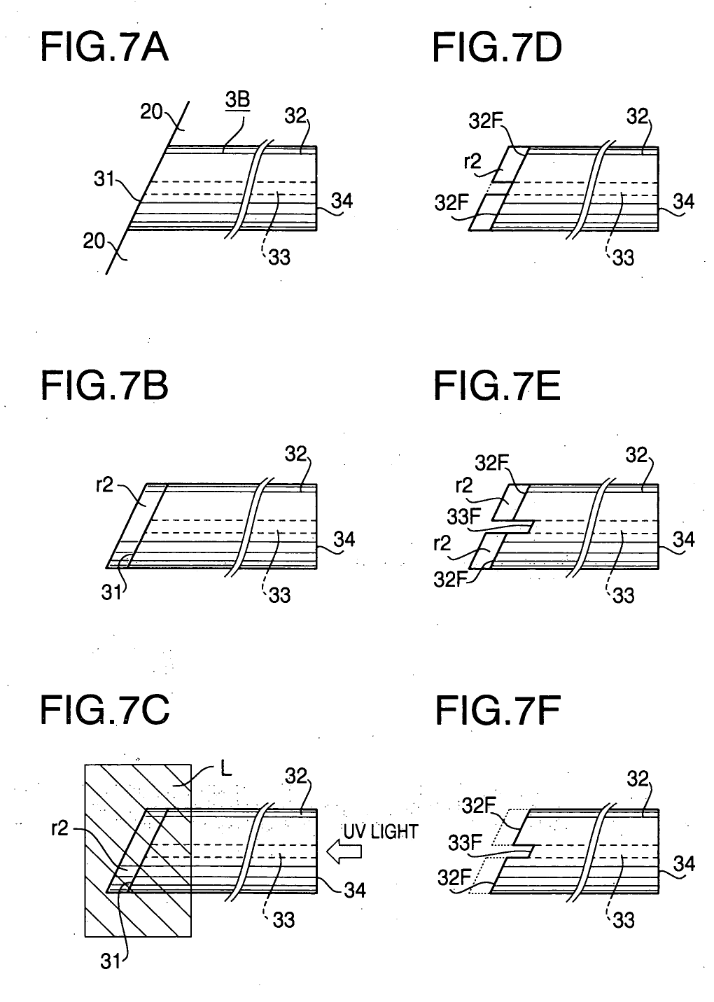

FIGS. 7A to 7F are schematic side views for explaining the method of processing an optical fiber according to the fourth embodiment. In the fourth embodiment, the positive resist r2 is employed in a coating process. Since the processing method up to the exposing process of this embodiment is similar to the foregoing embodiments, the description is skipped. Also, the states of the optical fiber 3B shown in FIGS. 7A to 7C are generally the same as the states of the optical fiber 3A shown in FIGS. 2A to 2C, 4A to 4C and 5A to 5C, respectively.

In the method of processing according to the fourth embodiment also, the exposing process is followed by a level gap forming process. In the level gap forming process according to the fourth embodiment, firstly the development is carried out, through which the exposed positive resist r2 is removed. FIG. 7D depicts the optical fiber 3B that has undergone the developing process. As is apparent in view of FIG. 7D, only the portion of the positive resist r2 applied to the core facet 33F, which has been exposed, is removed in the fourth embodiment.

FIG. 7E depicts the optical fiber 3B that has been subjected to an etching process, on the state of FIG. 7D. In the fourth embodiment also, the dry etching process is employed as the first embodiment. In the optical fiber 3B shown in FIG. 7E, the core facet 33F has been etched such that the level gap between the core facet 33F and the clad facet 32F becomes λ/8. FIG. 7F depicts the optical fiber 3B from which the positive resist r2 has been stripped after the etching process, so that the clad facet 32F is exposed. At this stage, the optical fiber 3B obtains the structure shown in FIG. 6.

The method of processing that forms the recessed portion on the core facet 33F so as to create a level gap is not limited to the fourth embodiment. For example, in the second embodiment the positive resist r2 is employed. Accordingly, the material g is filled in the space defined by the core facet 33F and the positive resist r2 that has not been removed in the developing process, so as to form the level gap protruding on the core facet 33F. Such method of the second embodiment can be modified so as to form the level gap by creating a recessed portion on the core facet 33F, utilizing the negative resist. To achieve such modifications, a material identical to the clad 32, or a material having generally the same refractive index as the clad 32 may be coated on a region where the negative resist has been removed, i.e. the region corresponding to the clad facet 32F, in a predetermnined thickness. This leads to the formation of the level gap constituted of a recessed portion on the core facet 33F.

Now, the optical fiber 3A or 3B, provided with the level gap formed on the first facet 31 by the method of processing according to the foregoing embodiments, can be incorporated in an optical communication module such that the first facet 31 can serve as the light receiving facet for the light from the LD. Once this is completed, the optical communication module can constantly perform a positioning operation of adjusting the incident position of the light from the LD on the first facet 31, to the center of the core 33.

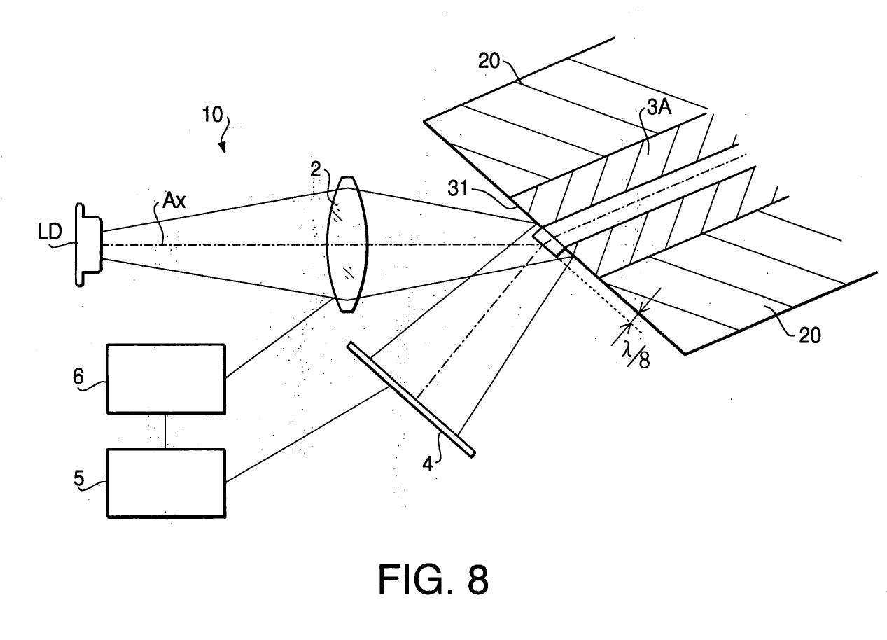

FIG. 8 is a schematic diagram showing a configuration of a optical communication module 10 implemented with the optical fiber 3A. The optical communication module 10 includes, in addition to the optical fiber 3, a laser diode (LD), a condenser lens 2, a photo detector 4, a controller 5 and an actuator 6. In practical use of the optical communication module 10, an incident angle at the optical fiber 3A, of a beam output by the LD and introduced to the optical fiber 3A via the condenser lens 2, is extremely small. However, for the sake of explicitness of the description, FIG. 8 illustrates a much wider incident angle than the actual angle. The optical fiber 3A is fixed inside the optical communication module 10 via the capillary 20. In this way, the capillary 20 serves not only as a sustaining member for the fine optical fiber during the processing work, but also as a fixing tool for attaching the optical fiber in the optical communication module 10.

The optical communication module 10 serves as an ONU that introduces the optical fiber communication into a subscriber's house. The optical communication module 10 supports an interactive WDM communication utilizing an optical fiber for transmitting an upstream signal having a wavelength of for example 1.3 μm, and for receiving a downstream signal having a wavelength of for example 1.5 μm.

The laser diode LD working as the light source of the transmission signal light is a surface emitting laser, which can be modulated according to the information to be transmitted. The optical fiber 3A is installed such that the first facet 31 confronts the first condenser lens 2. The first facet 31 (light receiving facet 31) of the optical fiber 3A is cut off along a plane that is not orthogonal to the extension of the optical fiber. Also, each component is configured such that the light from the LD is introduced to the light receiving facet 31 at an incident angle other than 0 degree. For example, when the first facet 31 is inclined by 30 degrees, the optical fiber 3A is oriented with an inclination of approx. 17 degrees with respect to the optical axis. With such configuration, the optical communication module 10 attains higher coupling efficiency, and leads the reflecting light from the light receiving facet 31 to the photo detector 4, without employing a deflecting component. In addition, a reference axis AX shown in a dash-dot line in FIG. 8 is the center axis serving as the reference for positioning, in the optical communication module 10.

The light emitted by the LD is converged by the condenser lens 2 so as to be incident upon the light receiving facet 31 of the optical fiber 3A, thus to create a spot. The condenser lens 2 is granted a power that can make the spot larger in diameter than the core facet 33F. When the beam converged so as to form a spot slightly larger in diameter than the core is incident upon both of the protruding core facet 33F and the clad facet 32F, diffraction takes place.

Accordingly, the light reflected by the light receiving facet 31 and incident upon the photo detector 4 forms a diffraction pattern. The photo detector 4 detects a light intensity distribution according to the diffraction pattern. Here, the light incident upon the photo detector 4 includes the light reflected by the core facet 33F which has a relatively high intensity. Therefore, in the case where the priority is given to suppressing the intensity of the reflected light, so that the photo detector 4 can precisely detect a minute variation of the diffraction pattern (light intensity distribution), it is desirable to employ the material g or the photo-curing resin P that has a lower refractive index than the clad 32, instead of generally the same refractive index as the core 33, in the method of processing according to the embodiments.

The controller 5 performs a negative feedback control so that light from the laser diode LD locates the center of the spot created on the light receiving facet 31 substantially at the center of the core facet 33F, based on the light intensity distribution detected by the photo detector 4. More specifically, the controller 5 drives the condenser lens 2 through the actuator 6 until the detected light intensity distribution matches the reference distribution, to thereby move the position of the spot on the light receiving facet 31. The reference distribution herein means a state that the center of the spot coincides with the center of the core facet 33F, i.e. the light intensity distribution obtained when a highest coupling efficiency is achieved.

As described above, employing an optical fiber processed by the method of processing an optical fiber according to the foregoing embodiment allows precisely adjusting an incident position of light on a light receiving facet (the first facet 31) to the center of the core facet 33F.

While the foregoing passages refer to the positioning operation in the optical communication module 10 implemented with the optical fiber 3A provided with the core facet 33F of a protruding shape, an optical communication module including the optical fiber 3B provided with the core facet 33F of a recessed shape can also perform a similar positioning operation.

As described above, according to the embodiments, a processing method that enables reducing a difference in refractive index at an interface between the photosensitive material applied to the first facet and an ambience, in the exposing process is provided. Therefore, the light for exposure from the second facet 34 can be effectively prevented from being reflected at the interface and thus exposing the photosensitive material applied to a region other than the core facet. This results in the precise formation of the level gap on the first facet, accurately at the boundary between the core facet 33F and the clad facet 32F. Further, by adopting the optical fiber processed according the embodiments in an optical communication module, a quick and high-precision positioning performance can be attained.

The present invention has been described in detail based on the preferred embodiment thereof, however it is to be understood that various modifications may be made without departing the scope of the present invention. To cite a few examples, the photosensitive material such as the resist r1, r2 or the photo-curing resin P is applied to an entire surface of the first facet 31 in the foregoing embodiments. However, the level gap can be duly formed provided that the photosensitive material is applied to a portion of the first facet 31 at least including an entirety of the core 33.

Also, the dimension of the level gap specified above is merely an example. Accordingly, the dimension of the level gap is not limited to the cited value, which is appropriate to the level gap formed at a boundary between the core facet and the clad facet. Further, according to the foregoing embodiments, the first facet of the optical fiber is obliquely cut off with respect to the optical axis of the optical fiber, so as to omit a deflecting member that leads the reflected light from the first facet to the photo detector, in the optical communication module. However, the method of processing according to the present invention can be equally effectively applied, irrespective of an angle of the first facet with respect to the optical axis of the optical fiber.

Further, in the foregoing embodiments, the solution L having generally the same refractive index as that of the photosensitive material is employed. However, the solution L and the photosensitive material do not imperatively have to accord in refractive index. As long as a difference in refractive index between the solution L and the photosensitive material is within a range that restricts the reflectance at the interface therebetween to be 1% or less, the method of processing according to the present invention can be effectively executed. Specifically, a solution having a refractive index that is different by approx. 0.2 from that of the photosensitive material may be selected.

What is claimed is:

1. A method of processing an optical fiber having a first facet and a second facet, comprising the steps of:
applying a photosensitive material to a region on the first facet at least including an entirety of a core in a generally uniform thickness;
irradiating light of a predetermined wavelength from the second facet through an inside of the optical fiber, with the first facet dipped in a predetermined solution that has generally the same refractive index as that of the photosensitive material, so as to expose only the photosensitive material applied to the core in the first facet; and
forming a level gap at a boundary between a core facet and a clad facet in the first facet, at least after the first facet lifted out of the solution undergoes development.

2. The method according to claim 1, wherein in the applying step, the photosensitive material is applied to an entire region on the first facet.

3. The method according to claim 1, wherein in the applying step, a negative resist is used as the photosensitive material.

4. The method according to claim 3, wherein the forming the level gap step includes the steps of:
performing an etching, after the development, on a region where the resist is no longer present; and
stripping the resist remaining on the first facet, after the etching.

5. The method according to claim 3, wherein the forming the level gap step includes the steps of:
filling a region where the resist has been removed in the first facet with a material that has generally the same refractive index as an end portion of the optical fiber corresponding to the region; and
removing the resist remaining on the first facet after the filling step.

6. The method according to claim 1, wherein in the applying step, a positive resist is used as the photosensitive material.

7. The method according to claim 6, wherein the forming the level gap step includes the steps of:
performing an etching, after the development, on a region where the resist is no longer present; and
stripping the resist remaining on the first facet, after the etching.

8. The method according to claim 6, wherein the forming the level gap step includes the steps of:
filling a region where the resist has been removed in the first facet with a material that has generally the same refractive index as an end portion of the optical fiber corresponding to the region; and
removing the resist remaining on the first facet after the filling step.

9. The method according to claim 1, wherein in the applying process, a photo-curing material that is optically transparent and hardens under light of a predetermined wavelength is used as the photosensitive material.

10. The method according to claim 9, wherein a height of the level gap is determined depending on a thickness of the photo-curing material applied to the first facet.

11. The method according to claim 10, wherein the photo-curing material has a lower refractive index than a clad of the optical fiber.

12. The method according to claim 1, wherein a holder larger in diameter than the optical fiber is used to hold at least a portion of the optical fiber.

13. The method according to claim 12, wherein the optical fiber is held by the holder such that the first facet and a facet of the holder are generally flush.

14. The method according to claim 13, wherein in the applying process, the photosensitive material is applied to an entire region including the first facet and the facet of the holder.

15. The method according to claim 1, wherein the first facet is not orthogonal to an optical axis of the optical fiber.

16. The method according to claim 1, wherein a difference between a refractive index of the predetermined solution and a refractive index of the photosensitive material is smaller than or equal to 0.2.
